(19) United States
(12) Patent Application Publication
(10) Pub. No.: US 2014/0126571 A1
(43) Pub. Date: May 8, 2014

(54) TELEPHONE EXCHANGE APPARATUS, TELEPHONE EXCHANGE APPARATUS CONTROL METHOD, AND TELEPHONE SYSTEM

(71) Applicant: Kabushiki Kaisha Toshiba, Tokyo (JP)

(72) Inventors: Kazuhiro Sumi, Hino-shi (JP); Shingo Kimura, Hachioji-shi (JP)

(73) Assignee: KABUSHIKI KAISHA TOSHIBA, Tokyo (JP)

(21) Appl. No.: 14/151,575

(22) Filed: Jan. 9, 2014

Related U.S. Application Data
(62) Division of application No. 13/166,703, filed on Jun. 22, 2011.

(30) Foreign Application Priority Data
Nov. 16, 2010 (JP) 2010-256104

(51) Int. Cl. H04L 29/06

(52) U.S. Cl. CPC H04L 65/1069
USPC 370/352

(57) ABSTRACT

According to one embodiment, a telephone exchange apparatus includes a determining module, a memory and a controller. The determining module determines whether an IP address is transferred through a router, by information notified from the plurality of telephone terminals, when a telephone terminal requests registration. The memory stores a management table associating the terminal ID, the results of determination by the determining module, and the IP address. The controller refers to the management table registered in the memory, and executes one of a first process of establishing connection for communication in a peer-to-peer form between first and second telephone terminals, and a second process of relaying connection by using a relay function, based on a reference results of the management table.

### CROSS-REFERENCE TO RELATED APPLICATIONS

This application is a Divisional Application that is based upon and claims the benefit of priority to U.S. application Ser. No. 13/166,703, now abandoned, which is based upon and claims the benefit of priority from Japanese Patent Application No. 2010-256104, filed Nov. 16, 2010; the entire contents of which are incorporated herein by reference.

### FIELD

Embodiments described herein relate generally to a telephone exchange apparatus which establishes a communication session between a plurality of telephone terminals connected to a global network such as Internet or a private network such as a local area network (LAN), for example, a method of controlling the telephone exchange apparatus, and a telephone system including the telephone exchange apparatus and telephone terminals.

### BACKGROUND

An IP telephone system, which bidirectionally transmits and receives audio and video data as packet data in real time through an Internet protocol (IP), has become popular in recent years. In the IP telephone system, a plurality of IP telephone terminals belongs to a private network such as a local area network (LAN), a private network is connected to a global network such as a public network and Internet through a router, and multimedia data is transferred between IP telephone terminals and between an IP telephone terminal and a global network.

In the above system, a router includes a module as a network address translator (NAT). A NAT module converts an IP address assigned to an IP telephone terminal, to an IP address for communication by using one IP address previously assigned for communication, issues the converted address as a source IP address, and converts an IP address destined to a router supplied at reception, to an IP address destined to an IP telephone terminal.

In the above system, a call control server as a telephone exchange apparatus includes a module as a media relay server (MRS), so that a media session is established through a MRS between an IP telephone terminal on a global network and an IP telephone terminal on a private network. In this case, it is necessary to lead a user datagram protocol (UDP) packet of all IP telephone terminals into a call control server. This increases a voice delay and the load of a call control server and network.

In addition, information from an IP telephone terminal is rewritten by a router on the way to a call control server, and a connection route is not automatically determined. When realizing a peer-to-peer connection, for example, omitting a switching operation by a call control server, it is necessary to set information for each IP telephone terminal. Further, if an IP telephone terminal is relocated, it is necessary to change setting of a call control server.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a schematic block diagram showing an IP telephone system according to an embodiment;

FIG. 2 is a block diagram showing a configuration of a call control server according to an embodiment;

FIG. 3 is a table showing an example of content stored in a relay port identification table shown in FIG. 2;

FIG. 4 is a table showing an example of content stored in a media route selection table shown in FIG. 2;

FIG. 5 is a table showing an example of content stored in a connection start information table shown in FIG. 2;

FIG. 6 is a diagram showing an example of conventional connection for communication;

FIG. 7 is a flowchart of a procedure for registration of IP telephone terminals in a call control server according to an embodiment;

FIG. 8 is a flowchart of a procedure for writing data to a relay port identification table in a call controller of a call control server according to an embodiment;

FIG. 9 is a flowchart of a procedure for determining a connection route by a call controller at the start of a call;

FIG. 10 is a flowchart of a procedure for controlling a communication session by a call controller at the start of a call;

FIG. 11 is a sequence diagram showing negotiation when a call is made between an IP telephone terminal connected to a LAN and an IP telephone terminal controlled by a NAT router, in an embodiment;

FIG. 12 shows structures of UDP packet handled in an embodiment; and

FIG. 13 is a sequence diagram showing negotiation when a call is made between IP telephone terminals controlled by a NAT router, in an embodiment.

### DETAILED DESCRIPTION

Various embodiments will be described hereinafter with reference to the accompanying drawings. In general, according to one embodiment, a telephone exchange apparatus comprises a determining module, a memory and a controller. The determining module determines whether an IP address is transferred through a router, by information notified from said plurality of telephone terminals, when a telephone terminal requests registration. The memory stores a management table associating the terminal ID, the results of determination by the determining module, and the IP address. The controller refers to the management table registered in the memory, and executes one of a first process of establishing connection for communication in a peer-to-peer form between first and second telephone terminals, and a second process of relaying connection by using a relay function, based on a reference results of the management table.

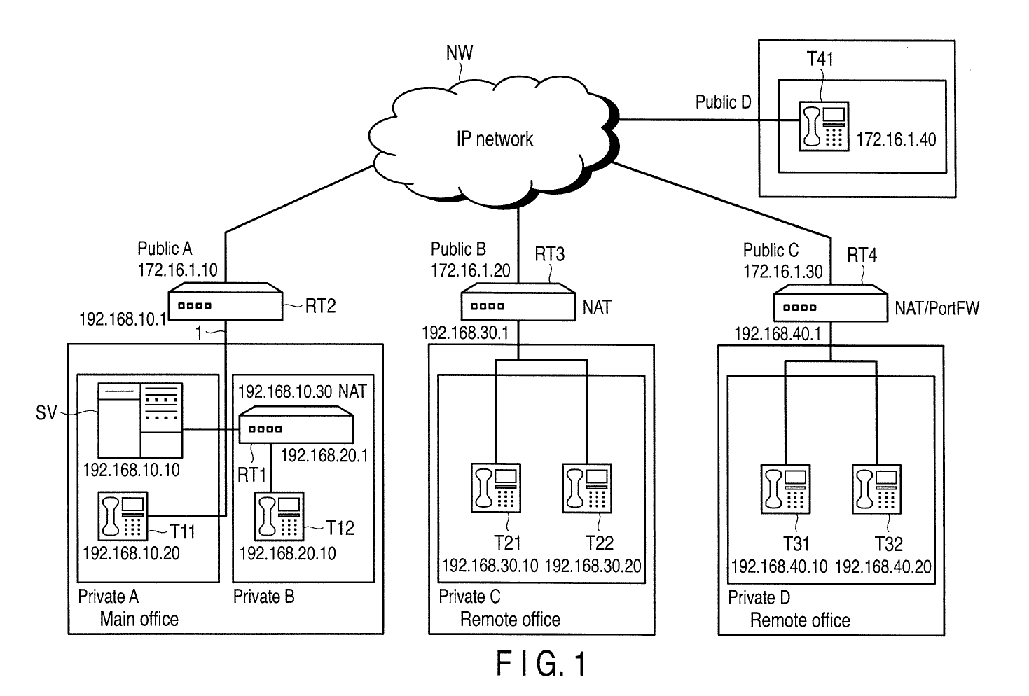

FIG. 1 shows a schematic block diagram of an IP telephone system according to an embodiment.

The system has a local area network (LAN) 1 as a private network at a main office located in Public A, for example. A LAN 1 is connected to an IP telephone terminal T11, a call control server SV as a telephone exchange apparatus, and NAT routers RT1 and RT2. A NAT router RT1 is connected to an IP telephone terminal T12. A NAT router RT1 includes modules of converting a source IP address included in a header of a UDP packet from an IP telephone terminal T12, to an IP address assigned to a NAT router RT1, and converting an IP address destined to a NAT router RT1 included in a header of received UDP packet, to an IP address of an IP telephone terminal T12.

IP telephone terminals T11 and T12 are terminals including a call processing module, and a media data processing module.

A router RT2 connects a LAN 1 to an IP network NW as a global network. An IP network NW is connected to a NAT router RT3 located in Public B, NAT router RT4 located in Public C, and IP telephone terminal T41 located in Public D. A NAT router RT3 is connected to IP telephone terminals T21 and T22. A NAT router RT4 is connected to IP telephone terminals T31 and T32. IP telephone terminals T21, T22, T31, T32, and T41 include a call processing module, and a media data processing module.

A call control server SV includes a switching control module to establish a session according to a session initiation protocol (SIP), for example, between IP telephones T11 and T12, or between IP telephone terminals T11, T12 and IP telephone terminals T21, T22, T31, T32, T41 on an IP network NW. After establishing a session, the call control server SV executes voice communication by transmitting/receiving a UDP packet in peer-to-peer connection between originating and incoming telephone terminals, or by MRS relay using a media data processing module of the call control server SV. A media data processing module for MRS relay is not limited to a media data processing module of the call control server SV. It may be MRS relay using a media data processing module of another server connected to an IP network NW.

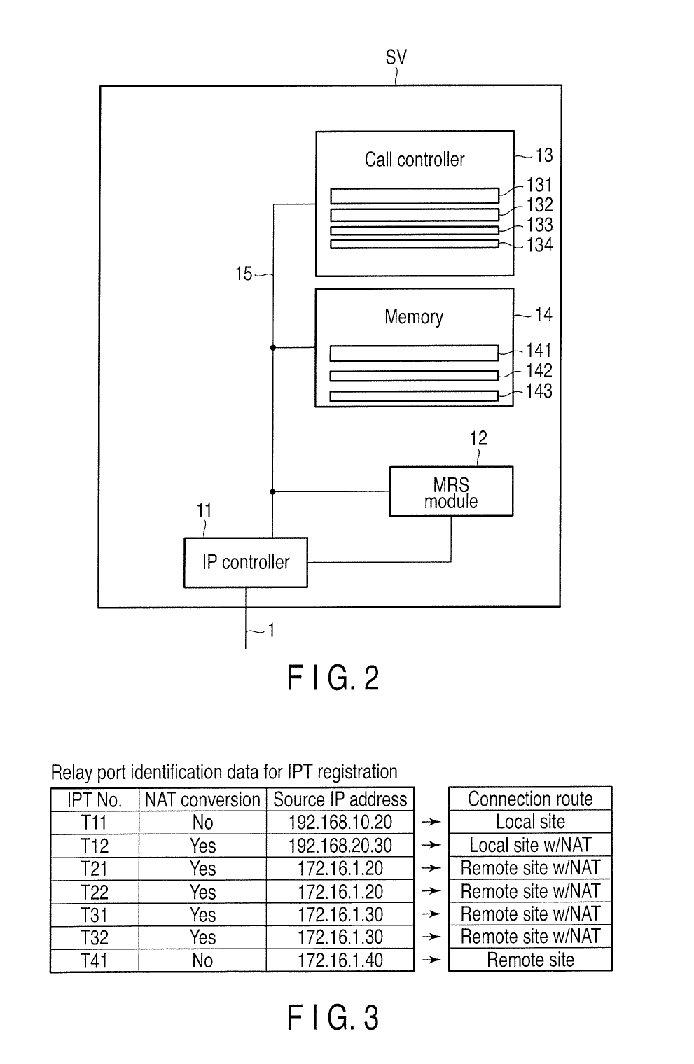

The above call control server SV includes the following modules in the embodiment. FIG. 2 is a block diagram showing a configuration of the call control server SV.

The call control server SV comprises an IP controller 11, a MRS module 12, a call controller 13, and a memory 14. The IP controller 11, MRS module 12, call controller 13, and memory 14 are connected through a data highway 15.

The IP controller 11 is connected to a LAN1 if necessary. The IP controller 11 interfaces with a connected LAN 1. The IP controller 11 transfers various control data about the interface with the call controller 13 through the data highway 15.

A MRS module 12 performs port transfer through a router RT2, as between an IP telephone terminal T11 on LAN 1 and IP telephone terminals T21, T22, T31, T32, T41 on IP network NW, and establishes a communication session even if peer-to-peer connection is impossible, and processes a control message and UDP packet received by the IP controller 11. When processing a UDP packet, the MRS module 12 stores a source IP address and port number added to a header of a UDP packet, and instructs a destination IP telephone terminal to return a UDP packet by using the stored IP address and port number.

A call controller 13 comprises a CPU, a ROM, and a RAM, and controls each part of a call control server SV by software processing.

A memory 14 stores routing data necessary for connection control of a call controller 13. The routing data associates terminal IDs previously assigned to IP telephone terminals T11, T12, T21, T22, T31, T32 and T41, with IP addresses as variable network addresses. A memory 14 includes a relay port identification table 141 (a table 141), a media route selection table 142 (a table 142), and a call start data table 143 (a table 143).

A table 141 is used to manage a connection route of registered IP telephone terminals T11, T12, T21, T22, T31, T32 and T41. As shown in FIG. 3, the table 141 associates IPT numbers as terminal IDs previously assigned to IP telephone terminals T11, T12, T21, T22, T31, T32 and T41, data indicating whether to make NAT conversion, and source IP addresses.

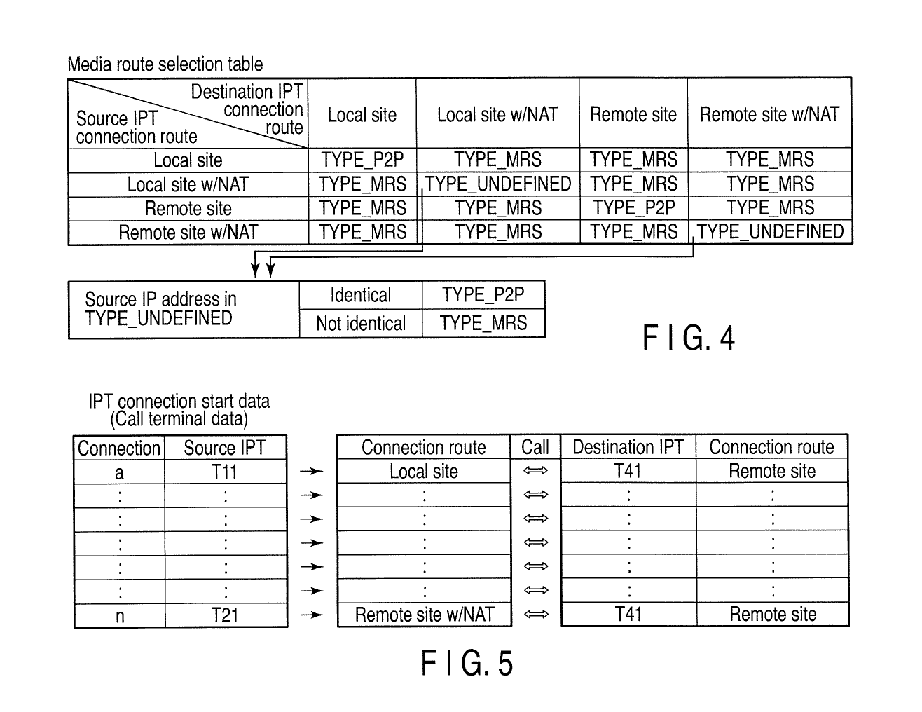

As shown in FIG. 4, the table 142 discriminates between peer-to-peer connection and MRS connection, by combining a connection route of an originating (source) IP telephone terminal and a connection route of an incoming (destination) IP telephone terminal.

A table 143 stores data indicating the states of call connection between IP telephone terminals T11, T12, T21, T22, T31, T32, and T41, as shown in FIG. 5.

A call controller 13 comprises a NAT conversion determining module 131, a table generator 132, a session controller 133, and a table updating module 134.

A NAT conversion determining module 131 compares a source IP address included in a header with a source IP address included in a payload of a control packet notified from the IP telephone terminal T11, T12, T21, T22, T31, T32, T41, when a request to register a terminal ID is made by the IP telephone terminal T11, T12, T21, T22, T31, T32, T41, and determines whether the address is converted by a NAT router. If the source IP addresses are identical, it is determined to be “without NAT conversion”. If the source IP addresses are not identical, it is determined to be “with NAT conversion”.

A table generator 132 generates a table 141 associating an IPT number as a terminal ID, the determination result of the NAT conversion determining module 131, and an IP address, and stores the table 141 in the memory 14.

A session controller 133 executes one of peer-to-peer connection and connection by leading a communication path into a MRS module 12, when a call is started at IP telephone terminals T11, T12, T21, T22, T31, T32, and T41. At this time, the session controller 133 searches the table 143 for the states of session at IP telephone terminals T11, T12, T21, T22, T31, T32, and T41, and controls a session. For example, if a session is not established for IP telephone terminals T11 and T12 when a call is going to be started, the session controller 133 controls to establish a session for the IP telephone terminals T11 and T12. When a session is established for the IP telephone terminals T11 and T12, the session controller 133 stores data indicating that the IP telephone terminals T11 and T12 are “talking”, in the table 143.

When the IP telephone terminal T11 is relocated from the LAN 1 to a LAN of a remote office (Private D), for example, the table updating module 134 updates the content of the table 141 based on a registration request from the IP telephone terminal relocated to a LAN of Private D. When an IP telephone terminal is added to or deleted from the LAN 1, or when the type of IP telephone terminal is changed, table updating module 134 updates the content of table 141.

Next, the operation with the above configuration will be explained.

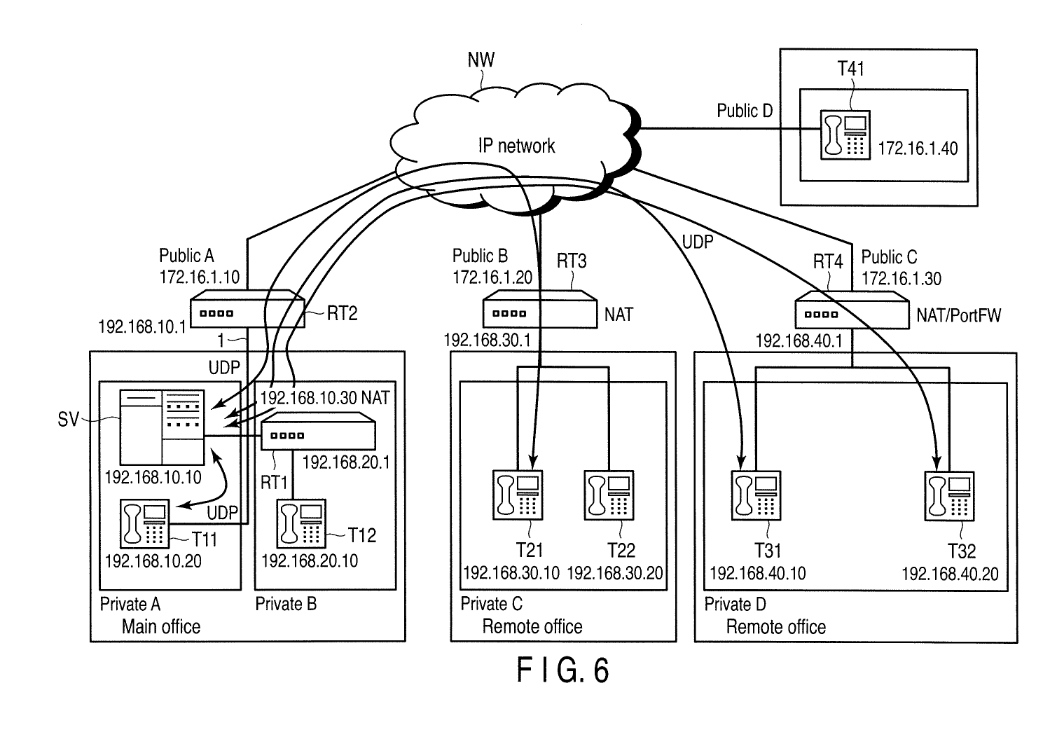

Conventionally, as shown in FIG. 6, an IP telephone terminal belonging to an IP network NW makes a call connection to a control server SV installed under a NAT router or in LAN 1, through a MRS module 12 of the call control server SV, without using a virtual private network (VPN).

However, in this form, it is necessary to lead UDP packets sent from all IP telephone terminals into the call control server SV. This increases a voice delay and the loads of the call control server SV and main office network.

In this embodiment, when IP telephone terminals T11, T12, T22, T31, T32, and T41 are registered to a call control server SV, a table 141 for recording data indicating with or without NAT conversion and destination IP addresses is generated by using data in a payload unable to be rewritten by a NAT router, so that a call can be automatically determined to be a peer-to-peer call, or a call by leading a connection route between IP telephone terminals into the MRS module 12.

### Registration of Terminals

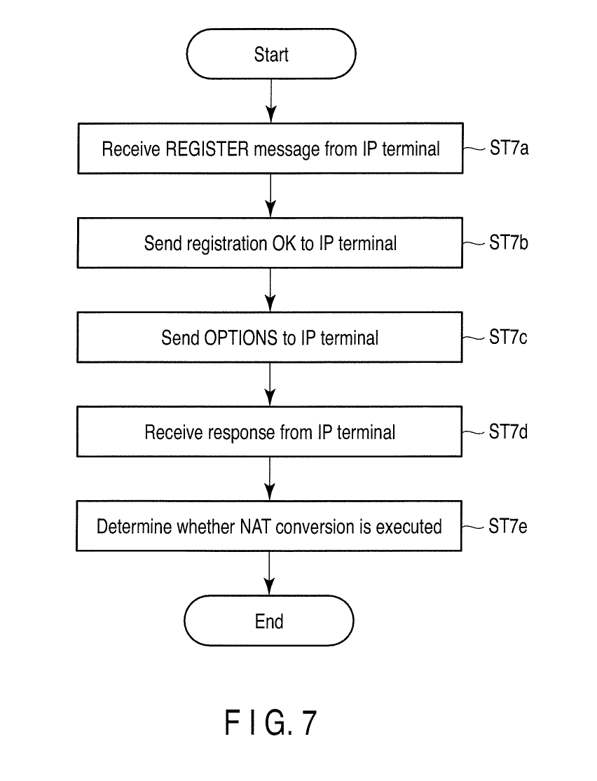

FIG. 7 is a flowchart of a procedure for registration of IP telephone terminals T11, T12, T21, T22, T31, T32 and T41 in a call control server SV. Here, a session initiation protocol (SIP) is explained as an example.

In case of SIP, a REGISTER message is sent from each of IP telephone terminals T11, T12, T21, T22, T31, T32 and T41 at regular intervals to request a call control server SV to make registration. Receiving a REGISTER message, a call control server SV registers IP numbers of IP telephone T11, T12, T21, T22, T31, T32 and T41 in table 141. If IP a telephone terminal T41 does not send a REGISTER message at regular intervals, for example, the call control server SV recognizes that the IP telephone terminal T41 is not present (or the power is turned off), and the IP telephone terminal T41 cannot make a call.

For example, if a REGISTER message is received from a IP telephone terminal T11 (block ST7a), the call control server SV checks the table 141 for registration, and if registration is accepted, the call control server SV returns ACK to the IP telephone terminal T11 (block ST7b).

Further, the call control server SV sends an OPTIONS message to the registered IP telephone terminal T11 to inquire about the capacity of the IP telephone terminal T11 (block ST7c). The call control server SV receives a response to OPTIONS from the terminal T11 (block ST7d), takes out SDP codec data included in the response message, and stores the data in the memory 14, and determines with or without NAT conversion (block ST7e).

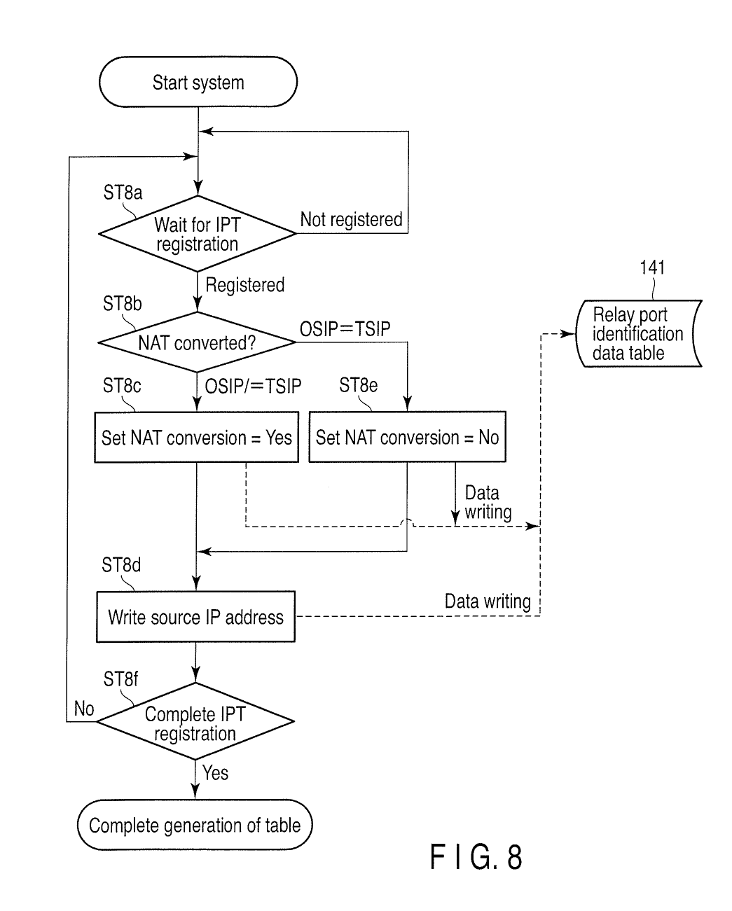

FIG. 8 is a flowchart of a procedure for writing data to a table 141 in a call controller 13 of a call control server SV.

First, the call controller 13 goes into a state of waiting for a REGISTER message from each of IP telephone terminals T11, T12, T21, T22, T31, T32 and T41 (block ST8a). When receiving a REGISTER message (registered), the call controller 13 sends an OPTIONS message to a registered IP telephone terminal T11, for example. Then, the call controller 13 compares a source IP address included in a header of a response message to OPTIONS from the telephone terminal T11, with a source IP address included in a payload, and determines with or without NAT conversion (block ST8b).

If the source IP addresses are not identical, the call controller 13 writes “with NAT conversion” to the table 141 by associating with the IPT number of the IP telephone terminal T11 (block ST8c), and writes the source IP address to the table 141 by associating with the IPT number of IP telephone terminal T11 (block ST8d).

If the source IP addresses are identical in block ST8b, the call controller 13 writes “without NAT conversion” to the table 141 by associating with the IPT number of the IP telephone terminal T11 (block ST8e).

Then, the call controller 13 determines whether the registration of IP telephone terminals T11, T12, T21, T22, T31, T32 and T41 to the table 141 is completed (block ST8f), and repeats blocks ST8a to ST8f until the registration is completed. When the registration is completed (Yes), the call controller 13 finishes generation of the table 141.

### Starting a Call

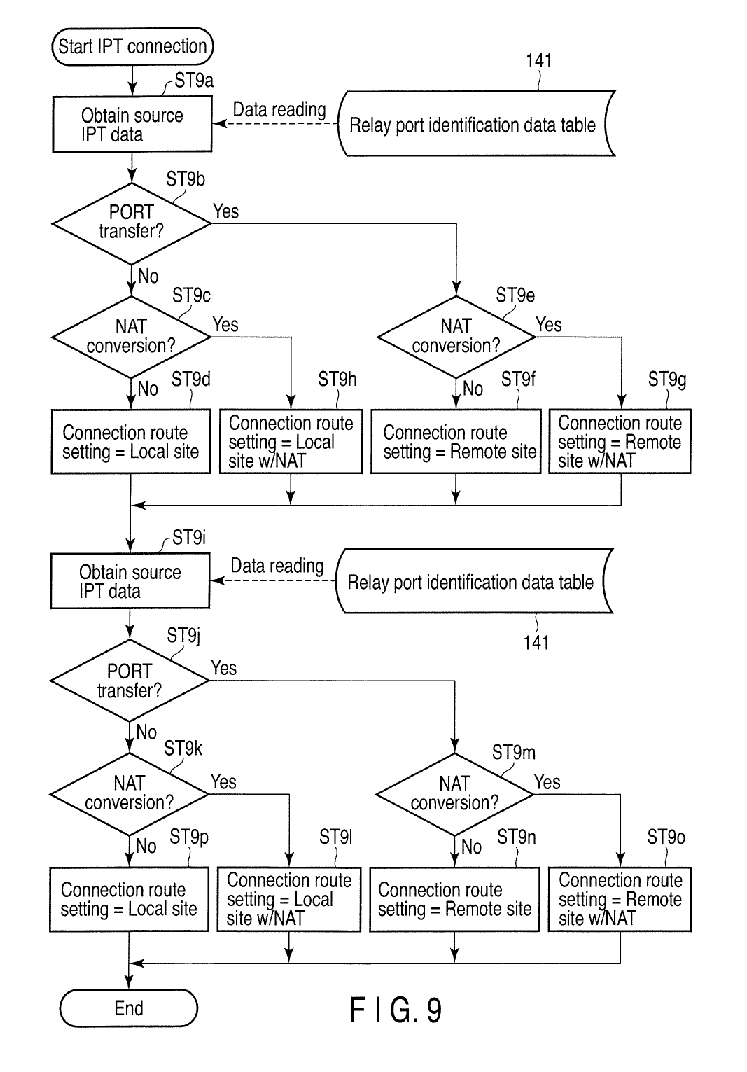

FIG. 9 is a flowchart of a procedure for determining a connection route of a call controller 13 at the start of a call.

If an originating message (an INVITE message) is received from an IP telephone terminal T11, for example, the call controller 13 reads the data corresponding to the IPT number of the IP telephone terminal T11 from the table 141 (block ST9a), and determines whether a port is transferred, or the IP telephone terminal is located beyond a router RT2 (block ST9b).

A port is not transferred here, and the call controller 13 determines with or without NAT conversion for the IP telephone terminal T11 (block ST9c). As the IP telephone terminal T11 is located without a NAT router, the call controller 13 determines it to be “Local site”, and registers “Local site” in the table 143 together with the IPT number of the IP telephone terminal T11 (block ST9d).

If an IP telephone terminal is located beyond a router RT2 in block ST9b, like an IP telephone terminal T41, the call controller 13 determines with or without NAT conversion for the IP telephone terminal T41 (block ST9e). As the IP telephone terminal T41 is located without a NAT router, the call controller 13 determines it to be “Remote site”, and registers “Remote site” in the table 143 together with the IPT number of the IP telephone terminal T41 (block ST9f).

If an IP telephone terminal belongs to a NAT router RT3 in block ST9e, like an IP telephone terminal T21, the call controller 13 determines it to be “Remote site w/NAT”, and registers “Remote site w/NAT” in the table 143 together with the IPT number of the IP telephone terminal T21 (block ST9g).

Further, if an IP telephone terminal belongs to a NAT router RT1 in block ST9c, like an IP telephone terminal T12, the call controller 13 determines it to be “Local site w/NAT”, and registers “Local site w/NAT” in the table 143 together with the IPT number of the IP telephone terminal T12 (block ST9h).

Then, the call controller 13 reads the data corresponding to the IPT number of the IP telephone terminal T12 for example that is a destination (a connected terminal) from the table 141 (block ST9i), and determines whether a port is transferred, or the IP telephone terminal is located beyond a router RT2 (block ST9j).

A port is not transferred here, and the call controller 13 determines with or without NAT conversion for the IP telephone terminal T12 (block ST9k). As the IP telephone terminal T12 is located via a NAT router RT1, the call controller 13 determines it to be a “Local site s/NAT”, and registers “Local site w/NAT” in the table 143 together with the IPT number of the IP telephone terminal T12 (block ST9l).

If an IP telephone terminal is located beyond a router RT2 in block ST9j, like an IP telephone terminal T41, the call controller 13 determines with or without NAT conversion for the IP telephone terminal T41 (block ST9m). As the IP telephone terminal T41 is located without a NAT router, the call controller 13 determines it to be “Remote site”, and registers “Remote site” in the table 143 together with the IPT number of the IP telephone terminal T41 (block ST9n).

Further, if an IP telephone terminal belongs to a NAT router RT3 in block ST9m, like an IP telephone terminal T21, the call controller 13 determines it to be “Remote site w/NAT”, and registers “Remote site w/NAT” in the table 143 together with the IPT number of the IP telephone terminal T21 (block ST9o).

If a destination is an IP telephone terminal on the LAN 1 for example in block ST9k, the call controller 13 determines it to be “Local site”, and registers “Local site” in the table 143 together with the IPT number of the IP telephone terminal on the LAN 1 (block ST9p).

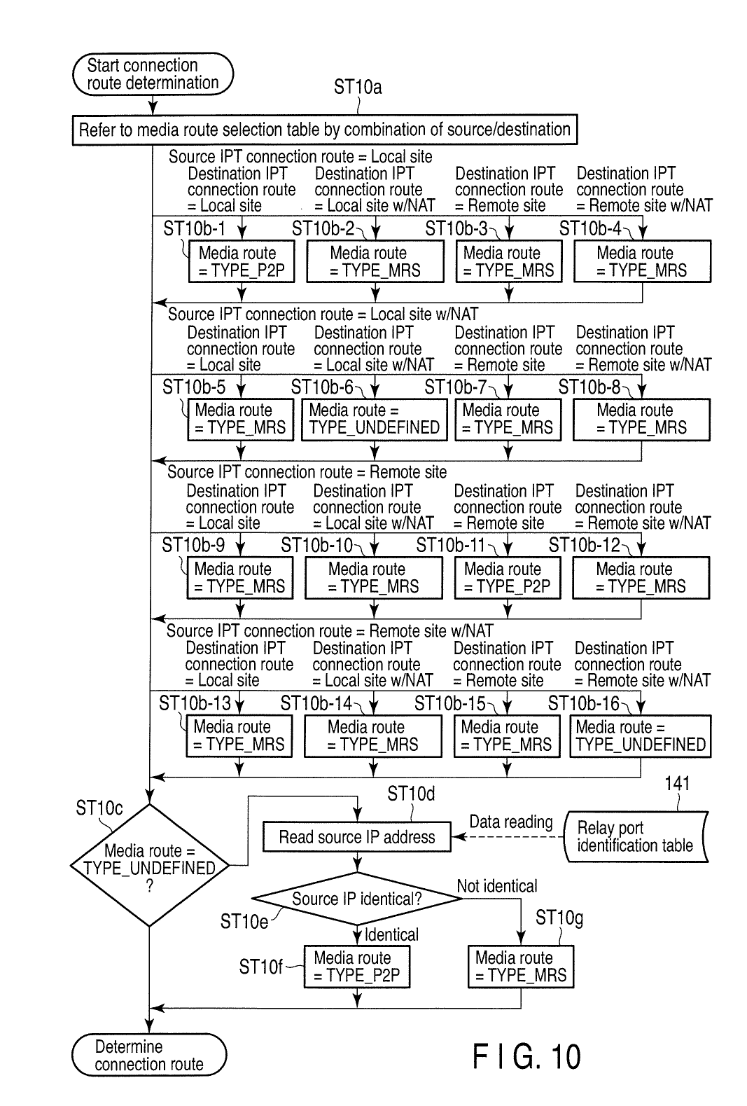

FIG. 10 is a flowchart of a procedure for controlling a communication session by a call controller 13 at the start of a call.

The call controller 13 determines a connection route in a transmission side, an a connection route in a reception side, refers to a media route selection table 142, and determines peer-to-peer connection if a transmission side is an IP telephone terminal T11 and a reception side is an IP telephone terminal on the LAN1 (block ST10b-1), and determines whether a media route is “TYPE UNDEFINED” (block ST10c). A media route is not “TYPE UNDEFINED” here, and the call controller 13 executes peer-to-peer connection.

On the other hand, if a transmission side is an IP telephone terminal T11 and a reception side is an IP telephone terminal T12 belonging to a NAT router RT1, for example, the call controller 13 determines connection “TYPE MRS” by a relay of MRS module 12 (block ST10b-2), and determines whether a media route is “TYPE UNDEFINED”. A media route is not “TYPE UNDEFINED” here, the call controller 3 executes connection by MRS relay.

If a transmission side is an IP telephone terminal T11 and a reception side is an IP telephone terminal T41 on the IP network NW, for example, the call controller 13 determines connection “TYPE MRS” by a relay of MRS module 12 (block ST10b-3), and determines whether a media route is “TYPE UNDEFINED”. A media route is not “TYPE UNDEFINED” here, the call controller 13 executes connection by MRS relay.

If a transmission side is an IP telephone terminal T11 and a reception side is an IP telephone terminal T21 belonging to a NAT router RT3, for example, the call controller 13 determines connection “TYPE MRS” by a relay of MRS (block ST10b-4), and determines whether a media route is “TYPE UNDEFINED”. A media route is not “TYPE UNDEFINED” here, the call controller 13 executes connection by MRS relay.

If a transmission side is an IP telephone terminal T12 and a reception side is an IP telephone terminal T11, for example, the call controller 13 determines connection “TYPE MRS” by a relay of MRS (block ST10b-5), and determines whether a media route is “TYPE UNDEFINED”. A media route is not “TYPE UNDEFINED” here, the call controller 13 executes connection by MRS relay.

If a transmission side is an IP telephone terminal T12 and a reception side is an IP telephone terminal T21 belonging to a NAT router RT3, for example, the call controller 13 determines a media route to be “TYPE UNDEFINED” (block ST10b-6), reads the source IP addresses of the transmission side and reception side from the table 141, and compares the addresses (block ST10d), and determines whether the source IP addresses are identical (block ST10e). If the source IP addresses are identical, the call controller 13 executes peer-to-peer connection (block ST10f).

If the source IP addresses are not identical, the call controller 13 executes connection by MRS relay (block ST10g).

Further, if a transmission side is an IP telephone terminal T12 and a reception side is IP telephone terminals T41 and T21, for example, the call controller 13 determines connection “TYPE MRS” by a relay of MRS module 12 (blocks ST10b-7 and ST10b-8).

If a transmission side is an IP telephone terminal T41 and a reception side is IP telephone terminals T11, T12 and T21, for example, the call controller 13 determines connection “TYPE MRS” by a relay of MRS module 12 (blocks ST10b-9, ST10b-10 and ST10b-12). If a transmission side is an IP telephone terminal T41 and a reception side is an IP telephone terminal on the IP network NW, for example, the call controller 13 determines peer-to-peer connection (block ST10b-11).

Further, if a transmission side is an IP telephone terminal T22 belonging to a NAT router RT3 and a reception side is IP telephone terminals T11, T12 and T41, for example, the call controller 13 determines connection “TYPE MRS” by a relay of MRS (blocks ST10b-13, ST10b-14 and ST10b-15). If a transmission side is an IP telephone terminal T22 belonging to a NAT router RT3 and a reception side is an IP telephone terminal 31 belonging to a NAT router RT4, for example, the call controller 13 determines a media route to be “TYPE UNDEFINED” (block ST10b-16).

### Connection by MRS Relay

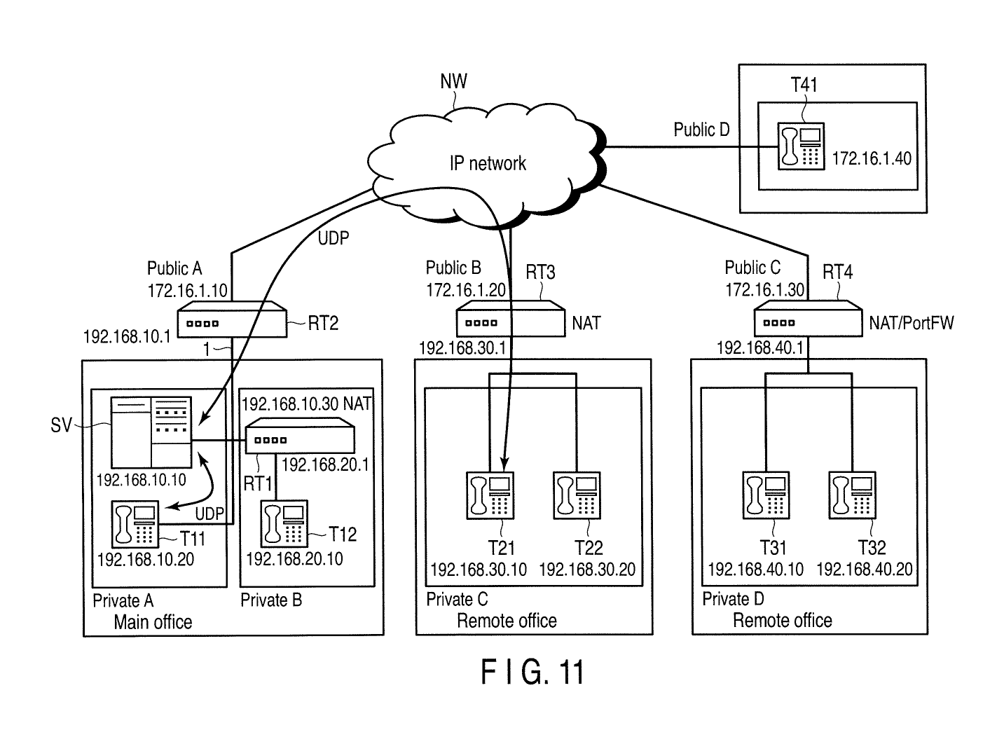

FIG. 11 is a sequence diagram showing negotiation when a call is made between IP telephone terminals T11 and T21, for example.

If the user of the IP telephone terminal T21 belonging to a remote office originates a call to the IP telephone terminal T11 belonging to a main office, for example, an originating message (an INVITE message) is sent from the IP telephone terminal T21 to a call control server SV via a NAT router RT3, IP network NW, router RT2, and LAN 1.

Receiving the originating message, the call control server SV refers to the table 141 based on the IPT numbers of the originating and incoming IP telephone terminals included in the originating message, and determines connection “TYPE MRS” by a relay of MRS module 12 based on the reference result. Then, the control server SV notifies the incoming IP telephone terminal T11 of information for connection by leading into MRS module 12 by superimposing it on an incoming message (an INVITE message to the incoming terminal).

The incoming IP telephone terminal T11 responds to the message. When the response message is sent back to the call control server SV, the call control server SV establishes a communication session (a media route) between the IP telephone terminals T11 and T21 by leading into MRS module 12.

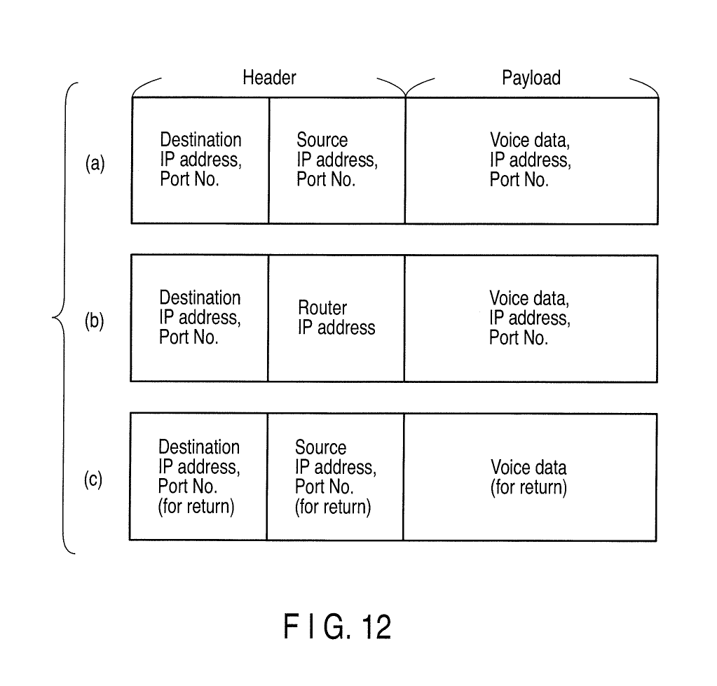

If a user's voice is input to the IP telephone terminal T21, the IP telephone T21 sends a NAT router RT3 a UDP packet by adding the voice data, the destination IP address and port number, and the source IP address and port number to a payload, and adding the destination IP address and port number and the source IP address and port number to a header, as shown in FIG. 12(a).

As shown in FIG. 12(b), the NAT router RT3 converts the destination IP address and port number added to the header of the input UDP packet, to the IP address and port number assigned to the NAT router RT3 itself, and sends the data to the IP telephone terminal T11.

The MRS module 12 of the call control server SV receives the UDP packet from the NAT router RT3, stores the source IP address and port number added to the header of the UDP packet, and instructs the IP telephone terminal T11 to send back the UDP packet by using the stored IP address and port number.

Receiving the user's voice, the IP telephone terminal T11 sends the UDP packet with the instructed IP address and port number added to the header, to the IP telephone terminal T21.

As shown in FIG. 12(c), the UDP packet transmitted from the IP telephone terminal T11 is sent to the IP telephone terminal T21, with the destination IP address and port number converted to the IP address and port number of the IP telephone terminal T21 by the NAT router RT3.

### Peer-To-Peer Connection

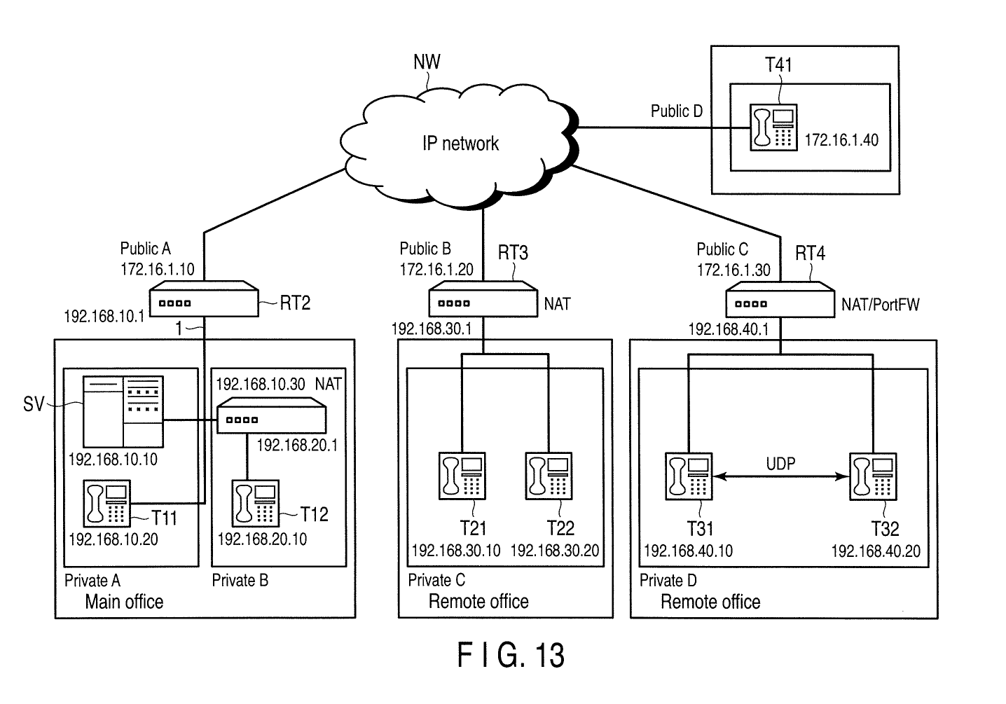

FIG. 13 is a sequence diagram showing negotiation when a call is made between IP telephone terminals T31 and T32.

If the user of the IP telephone terminal T31 belonging to a remote office (Private D) originates a call to the IP telephone terminal T32 belonging to a remote office (Private D), for example, an originating message (an INVITE message) is sent from the IP telephone terminal T31 to the call control server SV via a NAT router RT3, IP network NW, router RT2, and LAN 1.

Receiving the originating message, the call control server SV refers the table 141 based on the IPT numbers of the originating and incoming IP telephone terminals included in the originating message, and determines peer-to-peer connection based on the reference result. Then, the control server SV notifies the incoming IP telephone terminal T32 of information for peer-to-peer connection by superimposing it on the incoming message (an INVITE message to the incoming terminal).

The incoming IP telephone terminal T32 responds to the message. When the response message is sent back to the call control server SV, the call control server SV establishes a peer-to-peer communication session (a media route) between the IP telephone terminals T31 and T32.

As described above, in the above embodiment, when receiving a request to register IPT numbers of IP telephone terminals T11, T12, T21, T22, T31, T32 and T41 in the memory 14, the call control server SV compares the source IP addresses included in the headers of UDP packets sent from the IP telephone terminals T11, T12, T21, T22, T31, T32 and T41, with the source IP addresses included in the payloads, determines whether the addresses are converted by NAT routers RT1, RT3 and RT4, associates the determination result with the IPT numbers and IP addresses of the source IP telephone terminals, and records the data in the table 141. When a call is started, the call control server SV refers to the table 141, and executes one of peer-to-peer connection and connection via a MRS module 12 based on the reference result.

Therefore, it is possible to automatically determine a connection route between IP telephone terminals at the start of a call to be peer-to-peer call or call by leading into a MRS module 12, according to the table 141, thereby decreasing a voice delay, the processing load of the call control server SV, and the load of a network.

Further, in the above embodiment, a call control server SV includes a table updating module 134, which updates a table 141, when an IP telephone terminal on a LAN 1 or IP network NW is increased/decreased, changed or relocated. This eliminates re-registration of various setting data to a call control server SV, when an IP telephone terminal is relocated.

### Other Embodiments

In the embodiment described above, address conversion by a NAT router is determined by comparing the source IP addresses included in the header and payload of a UDP packet. Address conversion by a NAT router may be determined by any data notified from an IP telephone terminal when an IP telephone terminal is registered.

Further, in the above embodiment, address conversion by a NAT router is explained as an example. It is permitted to discriminate between peer-to-peer connection and MRS relay connection, by determining whether a port is transferred by a router.

Further, in the above embodiment, a SIP is used for registration of an IPT number of an IP telephone terminal in a call control server. Registration may be realized by using MEGACO.

Although embodiments have been explained, these embodiments are presented as an example, and not intended to limit the scope of the invention. These novel embodiments may be implemented in other various forms, and may be omitted, replaced or modified without departing from its spirit or essential characteristics. These embodiments and modifications come within the scope and spirits of the invention, and within the meaning and range of equivalency of the claims.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. (canceled)

2. A telephone exchange apparatus establishing a communication session between first and second telephone terminals connectable via a private network or a global network, the private network being connected to the global network through a network address translator (NAT), the telephone exchange apparatus comprising:
a determining module configured to (i) receive a communication packet having a header and a payload from the respective first and second telephone terminals when the respective first and second telephone terminals request registration, (ii) compare a first Internet Protocol (IP) address included in the header of the communication packet, with a second IP address included in the payload of the communication packet, and (iii) determine that address conversion has not been performed if the first and second IP addresses are identical, or to determine that the address conversion has been performed in the network address translator (NAT) if the first and second IP addresses are not identical;
a memory configured to store a management table associating a terminal ID of the telephone terminal, the determination as to whether the address conversion was performed, and an IP address; and
a controller configured to refer to the management table registered in the memory, and to execute a first process of establishing connection for communication in a peer-to-peer form between the first and second telephone terminals,
when the first and second telephone terminals are connected to a private network and the address conversion has not been performed,
when the first and second telephone terminals are connected to a global network and the address conversion has not been performed in the network address translator (NAT), or
when the first and second telephone terminals are connected to the global network through the private network, the address conversion has been performed in the network address translator (NAT), and the first IP addresses included in headers of communication packets from the respective first and second telephone terminals are identical,
the controller being configured to execute a second process of relaying connection between the first and second terminals by using a relay function, when the first process is not executed by the controller.

3. The telephone exchange apparatus of claim 2, wherein the controller executes the second process, when the first telephone terminal is connected to the private network, and the second telephone terminal is connected to the global network, and when the address conversion has been performed in the network address translator (NAT) and the first IP addresses included in headers of communication packets from the respective first and second telephone terminals are not identical.

4. The telephone exchange apparatus of claim 1, further comprising an updating module configured to update the management table, when a telephone terminal on the private network or global network is increased or decreased, changed, or relocated.

5. The telephone exchange apparatus of claim 1, wherein the first IP address is a first source IP address and the second IP address is a second source IP address.

6. The telephone exchange apparatus of claim 5, wherein the management table stored in memory includes the IP address being at least one of the first source IP address or the second source IP address.

7. A control method used in a telephone exchange apparatus establishing a communication session between first and second telephone terminals connectable via a private network or a global network, the private network being connected to the global network through a network address translator (NAT), the control method comprising:
receiving a communication packet having a header and a payload from the respective first and second telephone terminals when the respective first and second telephone terminals request registration;
comparing a first Internet Protocol (IP) address included in the header of the communication packet, with a second IP address included in the payload of the communication packet to determine (i) that the address conversion has not been performed if the first and second IP addresses are identical, or (ii) that the address conversion has been performed if the first and second IP addresses are not identical;
generating a management table associating a terminal ID of the telephone terminal, the determination as to whether the address conversion was performed, and an IP address, and storing the management table in a memory; and
referring to the management table registered in the memory, executing a first process of establishing connection for communication in a peer-to-peer form between the first and second telephone terminals,
when the first and second telephone terminals are connected to a private network and the address conversion has not been performed,
when the first and second telephone terminals are connected to a global network and the address conversion has not been performed in the network address translator (NAT), or
when the first and second telephone terminals are connected to the global network through the private network, the address conversion has been performed in the network address translator (NAT), and the first IP addresses included in headers of communication packets from the respective first and second telephone terminals are identical, and
executing a second process of relaying connection between the first and second terminals by using a relay function, when the first process is not executed by the controller.

8. The control method of claim 7, wherein the executing comprises executing the second process, when the first telephone terminal is connected to the private network and the second telephone terminal is connected to the global network, and when the addresses has been converted in the network address translator (NAT) and the first IP addresses included in headers of communication packets from the respective first and second telephone terminals are not identical.

9. The control method of claim 7, further comprising updating the management table, when a telephone terminal on the private network or global network is increased or decreased, changed, or relocated

10. The control method of claim 7, wherein the first IP address is a first source IP address and the second IP address is a second source IP address.

11. The control method of claim 10, wherein the management table stored in the memory includes the IP address being at least one of the first source IP address or the second source IP address.

12. A telephone system comprising:
a plurality of telephone terminals connectable via a private network or a global network; and
a telephone exchange apparatus configured to establish a communication session between the plurality of telephone terminals, the telephone exchange apparatus comprises:
a determining module configured to (i) compare, when a telephone terminal requests registration, a first Internet Protocol (IP) address included in a header of a communication packet received from the telephone terminal, with a second IP address included in a payload of the communication packet, and (ii) determine that the address conversion has not been performed if the first IP address included in the header and the second IP address included in the payload are identical or determine that the address conversion has been performed if the first IP address included in the header and the second IP address included in the payload are not identical;
a memory configured to store a management table associating a terminal ID of the telephone terminal, results of determination by the determining module as to whether the address conversion has been performed, and an IP address; and
a controller configured to refer to the management table registered in the memory, and to execute a first process of establishing connection for communication in a peer-to-peer form between first and second telephone terminals, when the first and second telephone terminals are connected to a private network and the address conversion has not been performed, when the first and second telephone terminals are connected to a global network and the address conversion has not been performed or when the first and second telephone terminals are connected to the global network or the private network, the address conversion has been performed, and converted first IP addresses included in headers of communication packets from respective telephone terminals of the plurality of telephone terminals are identical, the controller being configured to execute a second process of relaying connection by using a relay function, when the first process is not executed by the controller.

13. The telephone system of claim 12, wherein the controller executes the second process, when a first telephone terminal of the plurality of telephone terminals is connected to the private network and a second telephone terminal of the plurality of telephone terminals is connected to the global network, and when the address conversion has been performed and the IP addresses included in headers of communication packets from the respective plurality of telephone terminals are not identical.

14. The telephone system of claim 12, further comprising an updating module configured to update the management table, when a telephone terminal on the private network or global network is increased or decreased, changed, or relocated.

15. The telephone system of claim 12, wherein the first IP address is a first source IP address and the second IP address is a second source IP address.

16. The telephone system of claim 15, wherein the management table stored in the memory includes the IP address being at least one of the first source IP address or the second source IP address.
